(19) United States
(12) Patent Application Publication
(10) Pub. No.: US 2024/0386804 A1
(43) Pub. Date: Nov. 21, 2024

(54) GO AROUND DETECTION

(71) Applicant: THE WEATHER COMPANY, LLC, Brookhaven, GA (US)

(72) Inventors: Andrew T. Penrose, Dublin (IE); Steven Wayne Tomasi, Derry, NH (US)

(21) Appl. No.: 18/317,267

(22) Filed: May 15, 2023

(51) Int. Cl. G08G 5/02; G06N 20/00; G08G 5/00

(52) U.S. Cl. CPC G08G 5/025; G06N 20/00; G08G 5/0013; G08G 5/0021

(57) ABSTRACT

A system and method for detecting an occurrence of missed approach by an aircraft. The method receives position data for the aircraft, the aircraft having a destination airport. The method compares the position data for the aircraft with one or more conditions associated with destination airport. In response to the position data for the aircraft meeting one or more conditions for the destination airport indicative of a missed approach, a missed approach message is sent to at least one system that is monitoring the flight of the aircraft.

### BACKGROUND

The present disclosure relates to aviation, and more specifically, to determining that an aircraft has initiated a missed approach or a go-around at a particular airport.

A missed approach is a procedure used by pilots when they are unable to land an aircraft safely during an approach to an airport. In such a situation, the pilot would abort the landing and execute a missed approach, also known as a go-around. A missed approach could occur due to various reasons, including bad weather, an obstacle on the runway, or if the pilot does not have sufficient visibility to land safely.

During a missed approach, the pilot would apply full power to the engines, retract the landing gear, and climb to a safe altitude. The pilot would then follow the missed approach procedure outlined in the approach chart or instructed by the air traffic controller.

### SUMMARY

According to an embodiment of the present disclosure, a method for detecting an occurrence of missed approach by an aircraft comprising is provided. The method receives position data for the aircraft, the aircraft having a destination airport. The method compares the position data for the aircraft with one or more conditions associated with destination airport. In response to the position data for the aircraft meeting one or more conditions for the destination airport indicative of a missed approach, a missed approach message is sent to at least one system that is monitoring the flight of the aircraft.

Embodiments of the present disclosure are directed to a system for determining that a missed approach has been executed by an aircraft. The system includes a position determination module configured to determine a position of the aircraft in airspace. It also includes a go-around calculation engine that calculates values for a destination airport associated with a missed approach and stores these values in a go-around datastore. The system further includes a go-around detection engine that determines that the aircraft is executing a missed approached based on position data from the position determination module, the values stored in the go-around datastore for the destination area, and one or more conditions indicative of a missed approach.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram illustrating a system for detecting and responding to a go-around or missed approach according to embodiments.

FIG. 2 is a flow diagram illustrating a process for determining that an aircraft has executed a missed approach or a go-around according to embodiments.

FIG. 3 is a diagrammatic illustration of a computing environment according to embodiments.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the invention.

### DETAILED DESCRIPTION

Aspects of the present disclosure relates aviation, more specifically to determining that an aircraft has initiated a missed approach during the approach portion of a flight. While the present disclosure is not necessarily limited to such applications, various aspects of the disclosure may be appreciated through a discussion of various examples using this context.

In aviation, the approach phase of a flight typically begins after the aircraft has completed its enroute phase and is descending towards its destination airport. It is the portion of the flight during which the aircraft is preparing to land. During the approach phase, the aircraft is typically following a specific flight path, known as an approach procedure, which is designed to guide the aircraft to the runway in a safe and efficient manner. This procedure may involve flying specific headings and altitudes, and making use of navigation aids such as radio beacons and GPS. An approach can be flown visually or using instruments on the aircraft. As the aircraft approaches the airport, the pilots will communicate with air traffic control to obtain clearance for landing and receive instructions on how to proceed. They will also perform a series of checks and procedures to prepare the aircraft for landing, such as configuring the flaps and landing gear, and completing a final approach briefing.

A “missed approach” is a procedure followed by a pilot when an instrument or visual approach cannot be completed to a full-stop landing. The missed approach can be initiated at any time during the approach stage of a flight. A missed approach can be initiated for a number of reasons. For example, the aircraft may be approaching the runway at too steep of an angle, or too fast. The weather at the airport may no longer be conducive for the aircraft to land. This can occur because of conditions such as rain, wind, wind shear, snow or ice at or near the airport. Further, the conditions of the runway may require the initiation of a missed approach procedure prior to entering the final approach stage of the flight.

Upon initiating a missed approach, the pilots will usually follow a published missed approach flight pattern. These published patterns allow for an aircraft to execute a missed approach without needing to immediately contact the air traffic controller. The published missed approach pattern allows the aircraft to safely climb out and over the airport before receiving further instructions from air traffic control to either retry the approach, enter a holding pattern, or divert to another airport.

The approach phase ends when the aircraft has established itself on the final approach path to the runway and is ready to begin the landing flare. At this point, the aircraft is typically only a few miles from the runway and is descending at a steep angle. The pilots will continue to monitor the aircraft's speed, altitude, and trajectory as they prepare to touch down on the runway. If any situation occurs that makes it unsafe to continue the final approach and land the aircraft, the pilots may elect to initiate a “go-around”. A go-around is an aborted landing of an aircraft that is on final approach. A go-around can either be initiated by the pilot flying or requested by air traffic control for various reasons, such as an un stabilized approach or an obstruction on the runway. Further, upon executing the go-around procedures the pilots will navigate the aircraft according to the procedures laid out in the published missed approach pattern. For purposes of this disclosure, the terms missed approach and go-around are used interchangeably.

A flight dispatcher (also known as an airline dispatcher or flight operations officer) assists in planning flight paths, taking into account aircraft performance and loading, enroute winds, thunderstorm and turbulence forecasts, airspace restrictions, and airport conditions. Dispatchers also provide a flight following service and advise pilots if conditions change. They usually work in the operations center of the airline. In the United States and Canada, the flight dispatcher shares legal responsibility with the commander (i.e. the captain or pilot in command) of the aircraft (joint responsibility dispatch system).

A dispatcher during a duty shift, is assigned a number of flights typically around 30-50 flights per shift. The dispatcher who is managing these of flights has no way of knowing or being alerting that go-arounds or missed approaches are occurring unless the dispatcher pro-actively checks that the aircraft has landed or not. The earlier they know when a go-around or missed approach has occurred the dispatcher will have a better situational awareness of what is happening with the flights they manage.

The present disclosure detects that a go-around or missed approach event occurred. This is different from other approaches that attempt to predict that a go-around will occur. It detects uncharacteristic changes in the aircraft's speed and altitude within close proximity to the Destination airport, compared to a normal landing. Bad flight data occurs occasionally and is mostly overcome to prevent false positive results. Different sources of aircraft position reports are used as a data source.

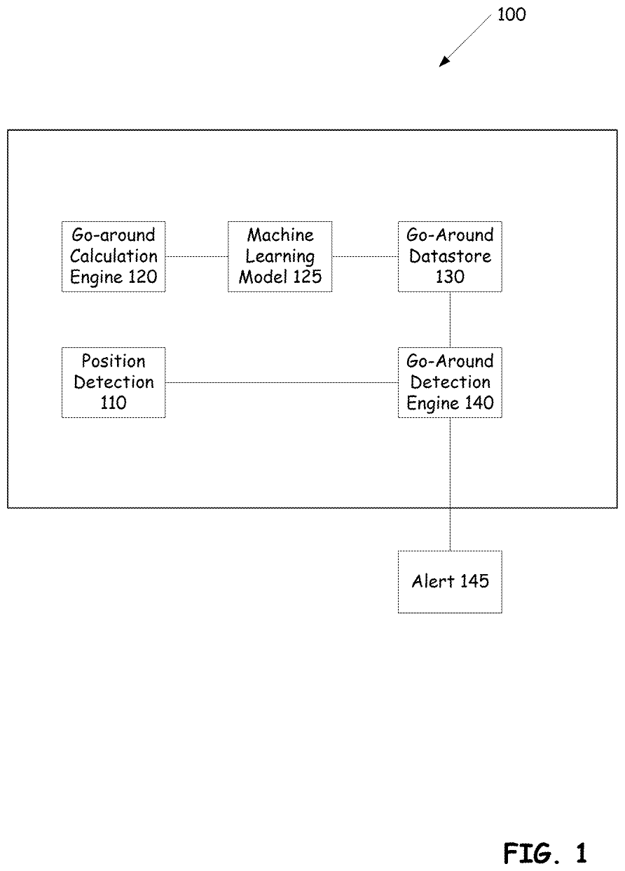

FIG. 1 is a block diagram of a system 100 for detecting and responding to a go-around event. The system 100 includes a position determination module 110, a go-around value calculation engine 120, an airport go-around datastore 130, and a go-around detection engine 140.

The position determination module 110 is a component of the system 100 that is configured to determine a relative position of an aircraft in the air. The position determination model can receive information from services such as ADS-B (Automatic Dependent Surveillance-Broadcast). ADS-B is a technology used in aircraft to enhance air traffic control and improve safety. It allows an aircraft to automatically broadcast its GPS-derived position, altitude, velocity, and other information to ground stations and other aircraft equipped with ADS-B receivers. Using ADS-B, an aircraft can be tracked more accurately and in real-time. This allows air traffic controllers to provide more efficient and safer separation between aircraft. ADS-B is also used for traffic and collision avoidance systems, as well as weather and flight information services. Other methods for determining the position of the aircraft can come from radar images created by various ground based systems. Radar images provide limited information about the aircraft such as distance from the radar source, altitude and speed. However, while radar provides some aspect of real-time monitoring it does not provide data at the same rate as other systems. Yet another method for obtaining information about the position of an aircraft can come from Aircraft Communications Addressing and Reporting System (ACARS). ACARS is a digital communications system that allows an aircraft to send and receive messages to and from ground stations. ACARS messages can contain position information and other flight data that has been derived from onboard equipment. The position determination module 110 uses information from one or more of these position reporting or determination sources to determine the position of the aircraft. Additional sources of aircraft position information can also be used by the position determination module 110.

The go-around value calculation engine 120 is a component of the system 100 that calculates values that are to be used for determining if a go-around or missed approach has occurred. The calculation engine can be configured to determine the values for a specific region, (e.g. all North American airports) or on a per airport basis. In some embodiments they calculation engine can use a generic set of rules that apply to all airports. The calculation engine calculates three different values for the airport that are used to determine if a go-around has occurred. These are a radius value, climb value, and a delay value. However, additional values can be included in the calculation such as a diversion value, or a fuel remaining value.

The radius value is a value that associates a specific distance from the airport at which point the system 100 will consider if certain rules are triggered a go-around is likely occurring. The radius value can be determined through observation or manual selection. For example, the system 100 can have the radius value set to 10 nautical miles from the airport based off of assumptions as to where a go-around is likely. In some embodiments, the radius value is a maximum distance from the airport where a go-arounds are likely to begin based on historical missed approach data. In some embodiments the radius value is calculated using historical data associated with missed approaches and go-arounds for the particular airport or region. In some embodiments, the radius value is calculated based on when the rules associated with a go-around has been triggered. This calculation is done using a computer system that is employing artificial intelligence and machine learning models 125.

A machine learning model is computer program that can learn from data and make predictions or decisions based on that data. The machine learning model implements an algorithm that learns patterns in data and then can act on new data based on the historical data. The machine learning model is trained on a set of training data related to the area that it is intended to make predictions or decisions on. During training the machine learning model adjusts its parameters to minimize the difference between its predicted labels and the actual labels in the training dataset. The machine learning models of the present disclosure can use any type of learning such as supervised learning, unsupervised learning or reinforcement learning. Further, the learning models can be retrained using data collected during real-world operations of the system 100.

The learning system can use data such as latitude and longitude of a flight when the rule has been triggered, the centroid of the airport, the calculated distance from triggering the rule and the centroid, and applying a buffer area as well. In some embodiments weather and other environmental conditions are also applied to the radius value calculation. Further, in some embodiments specific geographic considerations such as mountains or controlled airspace are added to the analysis.

By using a variable radius model based on the location of the airport it is possible to minimize the number of false positive results in the determination that a missed approach has occurred. Further, the machine learning model allows for the fine tuning of the radius value over time. The machine learning model can use a k-means clustering over small regions as the distances will be Euclidean. From these clusters the machine learning model can identify the location of airports centroids in these clusters and calculate the haversine distance from the centroid to all points to find the largest point as the radius value. The model can then apply a 10% additional value on the largest Radius Value and apply that for the destination airport. In some embodiments, the machine learning model can create a variable radius value for a particular airport based on different runways or approach patterns. This allows the system 100 to take into account the geographic features of the airport.

In some embodiments the machine learning model is augmented with a human in the loop approach to obtain feedback from users as to whether a particular go-around detection was correct. This feedback is then feed back into the historical training data. This can occur on for all instances where a user has provided feedback or when certain amount of such human triggers occurs, indicating a retraining is required for the model used to calculate the radius value.

The climb value is a value that is associated with an indication that a go-around or a missed approach is being executed. As an aircraft initiates a missed approach or go-around the aircraft may initially level off before beginning to climb out. The climb value for a particular airport can be calculated for each approach pattern for that airport. A second machine learning model can be trained to identify particular climb indicators based on a distance from the airport associated with a particular approach pattern. For example, the machine learning model can use the glide slopes associated with the approach pattern and the expected minimum and maximum altitudes at those distances to determine a particular climb value for that location. The climb value can be calculated as a rate of climb at that point in the approach that would be anticipated with an aircraft executing the published missed approach at that point in the approach. Alternatively, the climb value can be calculated based on a fixed rate associated with historical missed approaches. In other embodiments, the climb value is a virtual ceiling that if the aircraft exceeds that altitude at a particular point in the approach it is indicative of a missed approach. This virtual ceiling can follow along a glide slope associated with a particular approach. For example, the virtual ceiling can be x hundred feet above the published approach for a particular runway. Alternatively, the virtual ceiling can be calculated using historical variance between the published approach and aircraft that have not initiated a missed approach. Thus, if an aircraft remains at level flight during the approach at some point it will cross the climb value line of altitude. Again like the radius value the machine learning model can receive feedback on correct/incorrect detections of a missed approach with respect to the climb value or climb rate. These real life data sets can then be used to retrain the climb value model calculated by the machine learning.

The delay value is a value associated with the amount of time it takes for an aircraft to return to the same point in the approach where it was when a missed approach was executed. In some embodiments, the delay value can be the time from when the missed approach was determined until the time the aircraft lands at the airport. This approach allows for the delay value to include instances where the aircraft initiated a missed approach, but did not return to the same approach location. This can occur when the aircraft is given a different runway to land on after executing the missed approach. The delay times and the location within the approach are given to the machine learning model which then uses this data to learn the delay times expected with a go-around executed at a particular point within the approach pattern. This accounts for various different amounts of delay times based on where in the approach the go-around was executed. As generally the closer to the point of landing the longer the delay times can be. This is due to the need for a greater amount of required climbing as well as a need to increase speed due to the lower speeds associated with landing. In some embodiments, the delay value is a time required for the aircraft to get reestablished on the approach. This time can be used to ignore actions of the aircraft before reapplying the monitoring system 100. Again, feedback can be given to the learning model in response to real life examples which are then used to retrain the model as necessary.

The go-around datastore is a component of the system 100 that stores the calculated values from the machine learning models related to the radius value, the climb value and the delay value. In some embodiments the datastore is a database. However, other approaches for storing the data can be used. These values are stored for each airport or region that the system 100 is deployed in. The radius values that are stored are the radius values for the airport that should be applied when analyzing conditions 1-3 discussed below. The climb values that are stored are the climb values that should be applied when analyzing condition 2 discussed below. In some embodiments the stored climb value is associated with a specific radius value. The delay values that are stored are the delay values in minutes for the airport and are associated with the go-around time.

The go-around detection engine 140 is a component of the system 100 that is configured to determine that an aircraft is engaging in a go-around or missed approach. The go-around detection engine 140 receives from the position determination module 110 position information for each aircraft that is being monitored. The go-around detection engine 140 compares the received position of the aircraft with information stored in the go-around datastore. If the aircraft's position meets at least one of a preset number of conditions, then the detection engine determines that a missed approach or go-around is occurring with respect to that particular aircraft. Upon detection of a go-around the go-around detection engine 140 can generate an alert 145. This alert can go the dispatcher who is in charge of the flight. In some embodiments the ground crew at the destination airport can receive the alert. This allows for more efficient allocation of ground resources so they are able to be redeployed to other flights instead of waiting for a flight that has now been delayed.

In some embodiments, the detection engine employs 3 conditions. The first condition is triggered when an aircraft starts descending, slows down, is within the radius value for the specific airport of a destination airport and the detection engine has received 2 consecutive position reports indicating that the aircraft is both increasing speed and altitude. This allows for the aircraft to begin the approach phase of the flight and then abort the approach. These indications of both altitude and speed increasing are characteristic of a missed approach.

The second condition is triggered when an aircraft is within the radius value of a destination airport, is below an altitude threshold value and then climbs above the climb value for that airport and above its recorded minimum altitude while still remaining within the radius value. This allows for the system 100 to consider the actual approach pattern for the airport. While following the approach pattern the aircraft will generally follow a predetermined glide slope into the airport. This condition allows for the aircraft to deviate slight from the glide slope without triggering the condition. However, if they exceed a particular altitude at a particular point in the approach it is highly indicative of a missed approach.

The third condition is triggered when an aircraft is within the radius value of the destination airport and then moves further away from the airport. This condition can also consider if the aircraft's altitude is also increasing. By moving away from the airport this condition takes into account that an aircraft may initiate a missed approach and not gain altitude. Moving away from the airport indicates that the aircraft is not intending to land at this point in time. The lack of altitude gain can be the result of several conditions. For example, the aircraft may be experiencing a mechanical problem that limits the aircraft's ability to climb, or may be a result of the air traffic controllers instructions. An increase in altitude while moving away is a further indication that a missed approach is occurring.

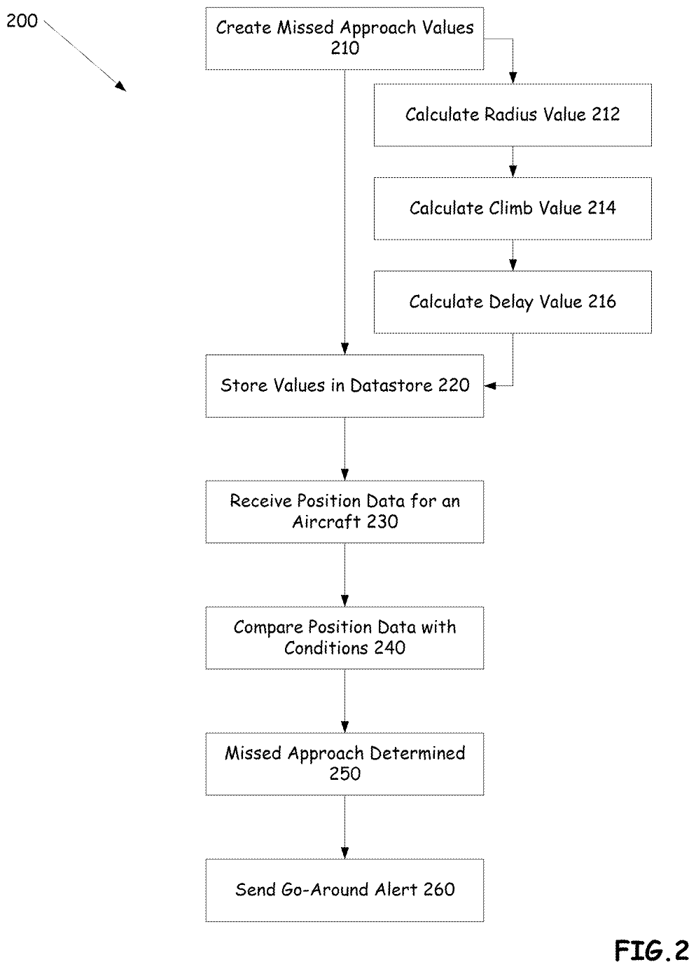

FIG. 2 is a flow diagram illustrating a process 200 for determining that an aircraft has executed a missed approach or a go-around according to embodiments of the present disclosure. The process begins by first creating a database of parameters associated with conditions indicative of a missed approach or a go-around. This is illustrated at step 210. The database is stored in a go-around datastore that is part of the associated system 100. To obtain the data for the database, the process calculates radius values, climb values and delay values for each airport that will be included in the go-around datastore 130. For purposes of this discussion, only one airport will be discussed. However, the process for calculating these values would be the same for multiple airports.

The process calculates the radius value or values for each airport that will be stored by the system 100. This is illustrated at step 212. To calculate the radius value the process uses a machine learning model to calculate a radius value for the airport. The machine learning model is fed with data of historical missed approaches and go-arounds for the airport. This data can include the latitude and longitude of a flight when the missed approach was initiated. It can also include information related to the type of aircraft, the speed of the aircraft and the altitude of the aircraft at the time the missed approach was initiated. This information can be sourced from a number of different historical sources such as saved flight data stored by flight recording services. In some embodiments, the data related to a missed approach can be downloaded from the aircraft's black box to obtain the flight parameters at the time of the execution. Other data can be included in this calculation as well, such as weather, geography, time of day, air traffic density, etc. In some embodiments the radius value can vary for each runway that is present at the airport. This allows for different approach patterns and the like to be considered in making these decisions.

The process calculates a climb value or climb values for each airport that will be stored by the system 100. This is illustrated at step 214. To calculate the climb value the process uses a second machine learning model to calculate a climb value for the airport. The climb value for a particular airport can be calculated for each approach pattern for that airport or a single value can be applied. The second machine learning model is trained to identify particular climb indicators based on a distance from the airport associated with a particular approach pattern. For example, the second machine learning model can use the glide slopes associated with the approach pattern and the expected minimum and maximum altitudes at those distances to determine a particular climb value for that location. The climb value can be calculated as a rate of climb at that point in the approach that would be anticipated with an aircraft executing the published missed approach at that point in the approach. Alternatively, the climb value can be calculated based on a fixed rate associated with historical missed approaches.

The process calculates a delay value or delay values for each airport that will be stored by the system 100. This is illustrated at step 216. To calculate the delay value the process uses a third machine learning model to calculate the delay values for the airport. The delay value is a value associated with the amount of time it takes for an aircraft to return to the same point in the approach where it was when a missed approach was executed. In some embodiments, the delay value can be the time from when the missed approach was determined until the time the aircraft lands at the airport. This approach allows for the delay value to include instances where the aircraft initiated a missed approach, but did not return to the same approach location. This can occur when the aircraft is given a different runway to land on after executing the missed approach. The delay value can also represent a period of time that it will take the aircraft to reestablish itself on the approach pattern. The delay value in this instance is representative of a period of time that the system 100 will ignore the movements of the aircraft for purposes of determining if a go-around or missed approach is occurring.

Once the various values are calculated using the machine learning models, the process proceeds to store these values for each airport in the go-around datastore. This is illustrated at step 220. The go-around datastore can store the data for all airports that values have been calculated for, can store only the data for airports that are in a specific region, or can store values for specific airports (e.g. only the airports that the particular dispatcher handles).

Once the system 100 has been deployed the process receives position information for each aircraft/flight that is being monitored. This is illustrated at step 230. To receive the position of the aircraft data can be received from a variety of data sources, such as ADS-B, ACARS, ground radar etc. The system 100, using the go-around detection engine 140, then compares the position information against a set of conditions associated with a missed approach for the particular airport. This is illustrated at step 240. In some embodiments, the conditions are only analyzed once a threshold number of position reports have been received for the aircraft. For example, two or more position reports from the aircraft within the radius value for the airport.

In an example embodiment, the process uses three conditions to determine if a missed approach is occurring. Meeting any one or more of the conditions can cause the process to determine that a missed approach has been executed. The first condition is triggered when an aircraft starts descending, slows down, is within the radius value for the specific airport of a destination airport and the detection engine has received two consecutive position reports indicating that the aircraft is both increasing speed and altitude. The second condition is triggered when an aircraft is within the radius value of a destination airport, is below an altitude threshold value and then climbs the above the climb value for that airport and above its recorded minimum altitude while still remaining within the radius value. The third condition is triggered when an aircraft is within the radius value of the destination airport and then moves further away from the airport. This condition can also consider if the aircraft's altitude is also increasing.

If one or more of the conditions are met for a particular flight the process determines that a missed approach has occurred. This is illustrated at step 250. As a result of the determination a notice of missed approach is issued by the system 100. This is illustrated at step 260. The notification can be for example a message to the dispatcher. The message can contain information about the particular aircraft that has executed the missed approach such as when in the approach stage the maneuver was executed. The message can also include information related to the delay value. This delay value can be used to calculate a new estimated time of arrival for the aircraft, or can be used to estimate when the aircraft will return to the same point in the approach pattern. This updated estimated time of arrival can be used by the dispatcher or ground personnel to more efficiently reallocate resources in real-time.

The process will return to step 230 and continue to monitor the aircraft until the aircraft has landed at the airport. However, in some embodiments, the process will pause the monitoring of the aircraft for another missed approach until after the delay value time period has occurred.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

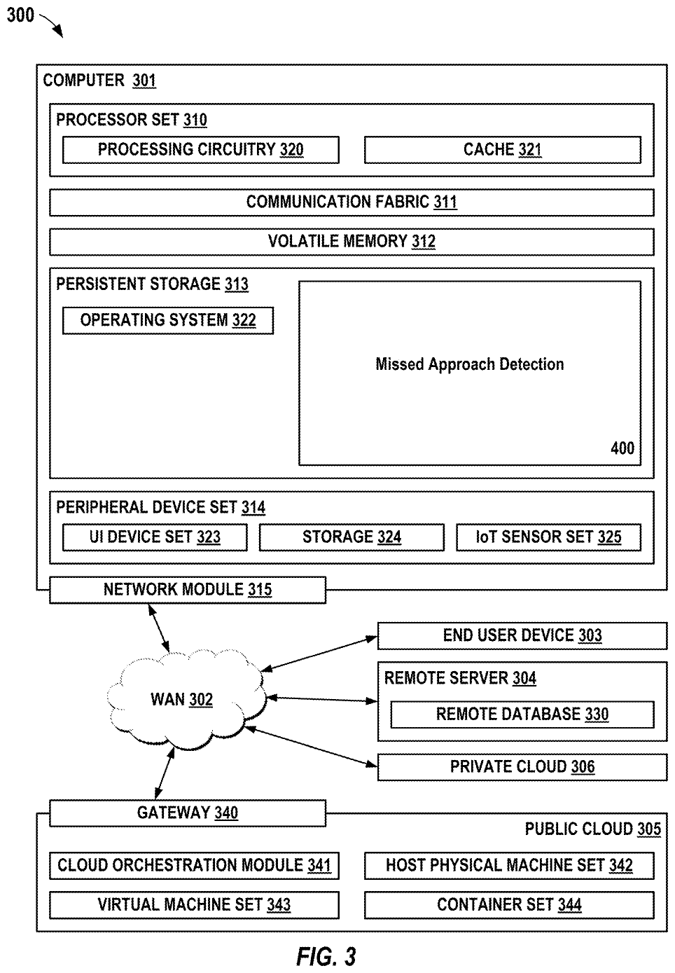

FIG. 3 is a diagrammatic illustration of a computing environment 300. Computing environment 300 contains an example of an environment for the execution of at least some of the computer code involved in performing at least a portion of the present disclosure, such as determining that an aircraft has executed a missed approach at a destination airport 400. In addition to block 400, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 400, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 321 and the other storage media discussed below. The program instructions, and associated data, are accessed by processor set 310 to control and direct performance of the disclosed methods. In computing environment 300, at least some of the instructions for performing the disclosed methods may be stored in block 400 in persistent storage 313.

Communications fabric 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 400 typically includes at least some of the computer code involved in performing the disclosed methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the disclosed methods can typically be downloaded to computer 301 from an external computer or external storage device through a network adapter card or network interface included in network module 315.

Wide area network (WAN) 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The present disclosure can be considered as well in view of the following clauses.
1. A method for detecting an occurrence of missed approach by an aircraft. The method includes receiving position data for the aircraft for a destination airport. The position data for the aircraft is compared with one or more conditions associated with destination airport. If the position data for the aircraft meets one or more conditions for the destination airport, a missed approach message is sent to at least one system configured to monitor the aircraft.
2. The method of clause 1 further comprises calculating a radius value, a climb value and a delay value for the destination airport. These values are calculated using machine learning models. Once the values have been calculated they are stored in a go-around datastore.
3. The method of clause 1 or 2 wherein calculating the radius value calculates the radius value based upon a distance from the destination airport where a historical number of missed approaches have been initiated.
4. The method of any of the preceding clauses wherein each approach to the destination airport has a corresponding radius value.
5. The method of any of the preceding clauses wherein the radius value is calculated based upon a maximum distance from the destination airport of missed approaches.
6. The method of any of the preceding clauses wherein the climb value is calculated based upon altitudes associated with historical missed approaches.
7. The method any of the preceding clauses wherein the climb value is a virtual ceiling associated with a particular approach to the destination airport.
8. The method of any of the preceding clauses wherein the delay value is calculated based upon a historical amount of time associated with historical missed approaches at the destination airport for the aircraft to return to a same point in the approach where the missed approach was initiated.
9. The method of any of the preceding clauses wherein in response to missed approach message being generated, stopping monitoring of the aircraft for a time associated with the delay value.
10. The method of any of the preceding clauses wherein the one or more conditions includes determining that the aircraft is descending and slowing down based on the position data; and receiving two or more position data points for the aircraft within the radius value for the destination airport indicating that the aircraft is increasing speed and increasing altitude.
11. The method of any of the preceding clauses wherein the one or more conditions includes determining that the aircraft is within a radius value for the destination airport and determining that the aircraft is below an altitude threshold and within the radius value from a first position data. Then determining that the aircraft is above the altitude threshold from a second position data.
12. The method of any of the preceding clauses wherein the altitude threshold varies as a function of distance from the destination airport.
13. The method of any of the preceding clauses wherein the one or more conditions includes determining that the aircraft is within the radius value for the destination airport based on the first position data; and determining the aircraft is moving away from the airport based on the second position data.
14. The method of any of the preceding clauses wherein the one or more conditions further includes determining that the aircraft is climbing based on the second position data.
15. A system for determining that a missed approach has been executed by an aircraft. The system includes a position determination module configured to determine a position of the aircraft in airspace. It also includes a go-around calculation engine that calculates values for a destination airport associated with a missed approach and stores these values in a go-around datastore. The system further includes a go-around detection engine that determines that the aircraft is executing a missed approached based on position data from the position determination module, the values stored in the go-around datastore for the destination area, and one or more conditions indicative of a missed approach.
16. The system of clause 15 wherein the values associated with a missed approach includes a radius value indicative of a maximum distance from the destination airport where a missed approach is considered to occur, a climb value indicative of an altitude and/or rate of climb where a missed approach is considered to occur; and a delay value indicative of an amount of time associated with execution of a missed approach.
17. The system of clauses 15 or 16 wherein the delay value is a period of time wherein the system ceases monitoring the aircraft following a missed approach.
18. The system of any of the preceding clauses wherein each runway of the destination airport has a corresponding climb value, and wherein the corresponding climb value decreases as the distance to the destination airport decreases.
19. The system of any of the preceding clauses wherein the go-around detection engine is further configured to alert one or more users that the aircraft has initiate a missed approach in response to determining that a missed approach has occurred.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for detecting an occurrence of missed approach by an aircraft comprising:
receiving position data for the aircraft, the aircraft having a destination airport;
comparing the position data for the aircraft with one or more conditions associated with destination airport; and
in response to the position data for the aircraft meeting the one or more conditions for the destination airport, sending a missed approach message to at least one to at least one system configured to monitor the aircraft.

2. The method of claim 1 further comprising:
calculating, using a machine learning model, a radius value for the destination airport;
calculating, using a second machine learning model, a climb value for the destination airport;
calculating, using a third machine learning model, a delay value for the destination airport; and
storing the radius value, climb value, and the delay value for the destination airport in a go-around datastore.

3. The method of claim 2 wherein calculating the radius value calculates the radius value based upon a distance from the destination airport where a historical number of missed approaches have been initiated.

4. The method of claim 3 wherein each approach to the destination airport has a corresponding radius value.

5. The method of claim 3 wherein the radius value is calculated based upon a maximum distance from the destination airport of missed approaches.

6. The method of claim 2 wherein the climb value is calculated based upon altitudes associated with historical missed approaches.

7. The method of claim 6 wherein the climb value is a virtual ceiling associated with a particular approach to the destination airport.

8. The method of claim 2 wherein the delay value is calculated based upon a historical amount of time associated with historical missed approaches at the destination airport for the aircraft to return to a same point in the approach where the missed approach was initiated.

9. The method of claim 2 wherein in response to missed approach message being generated, stopping monitoring of the aircraft for a time associated with the delay value.

10. The method of claim 1 wherein the one or more conditions comprises:
determining that the aircraft is descending and slowing down based on the position data; and
receiving two or more position data points for the aircraft within a radius value for the destination airport indicating that the aircraft is increasing speed and increasing altitude.

11. The method of claim 1 wherein the one or more conditions comprises:
determining that the aircraft is within a radius value for the destination airport;
determining that the aircraft is below an altitude threshold and within the radius value from a first position data; and
determining that the aircraft is above the altitude threshold from a second position data.

12. The method of claim 11 wherein the altitude threshold varies as a function of distance from the destination airport.

13. The method of claim 1 wherein the one or more conditions comprises:
determining that the aircraft is within a radius value for the destination airport based on a first position data; and
determining the aircraft is moving away from the airport based on a second position data.

14. The method of claim 13 wherein the one or more conditions further comprises:
determining that the aircraft is climbing based on the second position data.

15. A system for determining that a missed approach has been executed by an aircraft, comprising:
at least one processor;
at least one memory component;
a position determination module configured to determine a position of the aircraft;
a go-around calculation engine configured to use machine learning models to calculate values for a destination airport associated with a missed approach;
a go-around datastore configured to store the values for the destination airport associated with missed approach; and
a go-around detection engine configured to determine that the aircraft is executing a missed approached based on position data determined by the position determination module, the values stored in the go-around datastore for the destination area, and meeting one or more conditions indicative of a missed approach.

16. The system of claim 15 wherein the values associated with a missed approach comprises:
a radius value indicative of a maximum distance from the destination airport where a missed approach is considered to occur;
a climb value indicative of an altitude and/or rate of climb where a missed approach is considered to occur; and
a delay value indicative of an amount of time associated with execution of a missed approach.

17. The system of claim 16 wherein the delay value is a period of time wherein the system ceases monitoring the aircraft following a missed approach.

18. The system of claim 16 wherein each runway of the destination airport has a corresponding climb value, and wherein the corresponding climb value decreases as the distance to the destination airport decreases.

19. The system of claim 15 wherein the go-around detection engine is further configured to alert one or more users that the aircraft has initiate a missed approach in response to determining that a missed approach has occurred.

20. A computer readable storage medium having computer executable instructions that when executed cause at least one computing device to detect an occurrence of missed approach by an aircraft by:
receiving position data for the aircraft, the aircraft having a destination airport;
calculating missed approach values for the destination airport by:
calculating, using a machine learning model, a radius value for the destination airport;
calculating, using a second machine learning model, a climb value for the destination airport;
calculating, using a third machine learning model, a delay value for the destination airport; and
storing the radius value, climb value, and the delay value for the destination airport in a go-around datastore;
comparing the position data for the aircraft with one or more conditions associated with destination airport; and
in response to the position data for the aircraft meeting the one or more conditions for the destination airport, sending a missed approach message to at least one to at least one system configured to monitor the aircraft.
